(19) United States
(12) Patent Application Publication
(10) Pub. No.: US 2022/0364392 A1
(43) Pub. Date: Nov. 17, 2022

(54) COMPOSITE COMPONENT FOR A MOTOR VEHICLE LOCKING SYSTEM

(71) Applicant: Kiekert AG, Heiligenhaus (DE)

(72) Inventors: Eugen WOJTALLA, Mettmann (DE); Stephan MEUTERS, Korschenbroich (DE)

(21) Appl. No.: 17/620,178

(22) PCT Filed: Jun. 15, 2020
(86) PCT No.: PCT/DE2020/100495

§ 371 Date: Jan. 10, 2022

(30) Foreign Application Priority Data
Jun. 21, 2019 (DE) 10 2019 116 793.0

(51) Int. Cl. E05B 77/06; E05B 15/16

(52) U.S. Cl. CPC E05B 77/06; E05B 15/1635

(57) ABSTRACT

A method for producing a composite component and to a composite component for a motor vehicle locking system, consisting of a plastic material and a metal material, the composite component being producible from granules of a plastic material with at least one metal additive admixed thereto.

The invention relates to a composite component, preferably to a component for a motor vehicle locking system, and even more preferably to a mass inertia lever for a motor vehicle locking system, consisting of a plastic material and a metal material.

Locking systems, which are also referred to as locks, are used in motor vehicles where components that are movably attached to the motor vehicle, such as hoods, doors, flaps, covers, etc., have to be held securely during operation of the motor vehicle. Different requirements are placed on these locking systems and, depending on the application, different functions must be provided in the locking system. A high level of functionality, functional reliability, the available installation space, weight and/or environmental influences, to name just a few essential ones, can influence the construction and design of the locking systems. In addition, there are automotive industry requirements, which, for example, require favorable noise behavior. All these influences mean that continuous development work is carried out in order to provide a locking system that meets the requirements.

For the most part, locking mechanisms that consist of a rotary latch and at least one pawl are built into a locking system. The locking mechanism in the locking system interacts with a lock holder that is either attached to the body of the motor vehicle or to the door, flap, sliding door, etc. A relative movement between the lock holder and the rotary latch causes the rotary latch to be pivoted and at the same time the spring-biased locking pawl comes into engagement with the rotary latch in the rotary latch. Depending on the embodiment, there are one- or two-stage locking mechanisms, which then have a pre-ratchet and/or a main ratchet position. A release lever is used to unlock, that is, to release the locking pawl from the region of engagement with the rotary latch. The release lever acts on the locking pawl in such a way that the locking pawl disengages from the rotary latch and the rotary latch moves from the ratchet position into an open position. The rotary latch is mostly moved by means of a filter element and/or due to a tensile load resulting from the lock holder in combination with the door seal.

An actuating lever is used to actuate the release lever. The actuating lever can be, for example, an internal actuating lever or an external actuating lever. With the help of the actuating lever, the release lever is moved and the locking mechanism is unblocked.

To increase security in motor vehicles, locking systems are used that are equipped with mass inertia elements. The mass inertia elements counteract an external impulse and prevent, for example, a side door of a motor vehicle from being opened unintentionally. An impulse can be initiated, for example, by a collision with another vehicle. If, for example, in the event of a side impact, an impulse is introduced into the motor vehicle in such a way that, for example, a door handle of a side door is accelerated, the deflection of the door handle can cause the actuating lever to be activated and the locking mechanism to open, which can cause the side door to open unintentionally. In order to prevent such undesired events, locking systems based on mass inertia have become known, which counteract unintentional opening of a door lock.

A motor vehicle locking system equipped with a mass inertia element and, in particular, with a mass inertia lever is known from DE 10 2017 102 549 A1. The document discloses a motor vehicle locking system having a release lever chain, wherein an actuation lever can be moved by means of an outside door handle, for example, and the actuating lever interacts with a release lever to unlock a locking mechanism. To integrate a safety system based on mass inertia, a clutch lever is arranged between the actuating lever and the release lever. The clutch lever interacts with a mass inertia element via a control lever, wherein the clutch lever is deflected by means of the mass inertia element in the event of an unintentional, i.e., too rapid, actuation of the actuating lever, thus interrupting the actuating lever chain to unlock the locking mechanism. The mass inertia element remains in its initial position in the event of an impulse, i.e., if the actuating lever is initialized too quickly, and thus enables the clutch lever to be deflected.

In the case of such safety systems based on mass inertia, it is essential to the invention that the mass inertia element or the mass inertia lever has a corresponding weight in order to be able to counter the impulse with a necessary mass inertia.

The unpublished patent application DE 10 2018 116 313 disclosed a lock for a motor vehicle having a locking mechanism and an actuating lever chain, as well as a safety system based on mass inertia. Here, too, an actuating lever acts on a clutch lever that can be deflected by means of a mass inertia element in the form of a mass inertia lever in order to interrupt the actuating lever chain. The document discloses manufacturing the mass inertia element from a composite material made of a plastic material and, for example, iron. This also results in the advantage that a sufficient mass can be provided in the mass inertia element and, in addition, there is the possibility of making plastic parts of the mass inertia element available for contact with a bearing pin.

As already stated above, there are a number of influences that have an effect on the locking systems and, in addition, there are the specifications of the automotive industry, which play a decisive role in the development of motor vehicle locking systems. The developer of the motor vehicle locking systems is consequently faced with a number of challenges that are space-related, function-related and/or, for example, weight-related. This is the starting point of the invention.

The object of the invention is to provide an improved motor vehicle locking system. In addition, it is the object of the invention to provide a mass inertia element or a mass inertia lever for a motor vehicle locking system that can be manufactured inexpensively and at the same time enables a high degree of design freedom and at the same time meets the requirements of a modern motor vehicle locking system.

From a device point of view, this object is achieved by the features of independent claim 1 and from a procedural point of view by independent claim 10. Advantageous embodiments of the invention are specified in the dependent claims. It should be noted that the exemplary embodiments described below are not limiting; rather, any possible variations of the features described in the description, the dependent claims and the drawings are possible.

According to claim 1, the object of the invention is achieved in that a composite component, preferably a component for a motor vehicle locking system, and even more preferably a mass inertia element for a motor vehicle locking system, is provided, consisting of a plastic material and a metal material, wherein the composite component is producible from granules of a plastic material with at least one metal aggregate admixed thereto. The composite component according to the invention now creates the possibility, on the one hand, of being able to provide inexpensive producibility for a mass inertia element and, in particular, a mass inertia lever and, at the same time, of having a high degree of design freedom. The production of a composite component from plastic granules with metal aggregates admixed thereto makes it possible to combine the advantages of the plastic injection molding method with the positive properties of the metals. In this case, plastic injection molding allows quick and inexpensive producibility, as well as a high degree of design freedom, and the metal aggregates can be used to influence the weight of the composite component. The combination of a plastic component with an admixture of metal aggregates thus forms an advantageous combination of the properties of the production of plastic components with the properties of the unspecific weight of the metals, which are in this case positive. It is thus possible to provide composite components for the motor vehicle locking system that, in particular, meet the requirements for mass inertia in special dimensions.

It has been found to be advantageous that a composite component can preferably be produced when an aggregate in the form of iron and/or aluminum is admixed to the plastic material. Iron and/or aluminum are metal materials that are available inexpensively and in many forms as alloys. These materials are particularly suitable in that the mass of the composite component can be advantageously adjusted by means of the specific weights of the materials in an advantageous manner and with suitable admixture. In contrast to aluminum, iron has a high specific density, whereas aluminum has a specific density that is reduced by a third in relation to iron. Depending on the requirements, the composite component can thus be adapted to the requirements in the locking system. It should be noted that the inertia of the mass causes a counterforce, the size of which determines the reaction of the mass inertia system. The available installation space and the additional secondary functions in the motor vehicle locking system determine the geometry and the size of the mass inertia element, which can also be referred to as a mass oscillator. The resulting geometry must then be adjusted to the required mass moment of inertia by selecting an appropriate material density.

If an aggregate in the form of an iron oxide and/or an aluminum alloy is admixed to the plastic material, this results in a further embodiment of the invention. The admixing of an iron oxide has proven to be advantageous because it allows suitable weights to be achieved in the composite component and, at the same time, the high requirements for functional reliability and durability in the motor vehicle can be met. The requirements for corrosion resistance can also be met by the aggregates according to the invention. The aggregates iron oxide and/or aluminum alloys are therefore advantageously suitable as aggregates in order to meet the requirements for a motor vehicle locking system.

Another embodiment of the invention results when the plastic material is a polybutylene terephthalate (PBT) or a polyamide (PA). The plastic materials mentioned are particularly suitable for injection molding and thus for the production of complex structural components, as required by the reduced space requirement in the motor vehicle locking system. In addition, the materials mentioned, and in particular the polyamides, are characterized by high strength and toughness, so that they can advantageously be used as construction materials. In particular, however, with regard to the invention, it has been shown that the plastic materials are advantageously suitable for mixing with the aggregates.

If a degree of filling of 55% by weight to 85% by weight, preferably 60% by weight to 80% by weight, and even more preferably 65% by weight to 75% by weight of aggregates is admixed to the plastic material, an advantageous embodiment of the invention results. As already explained, the available installation space determines the geometry and size, i.e., the dimensions of the mass inertia element and in particular the mass inertia lever. In order to provide the required mass inertia in the motor vehicle locking system and, in particular, in the mass inertia system of the motor vehicle locking system, the weight of the composite component must be adjustable. It has been found that admixing approximately 70% by weight of aggregate is advantageously suitable for providing the necessary mass inertia in the motor vehicle locking system. Depending on the requirements and the available installation space, degrees of filling of 55% by weight as well as 85% by weight in the plastic material as an aggregate are also conceivable. Merely by way of example, a degree of filling of 70% by weight with iron oxide is to be specified here, wherein this degree of filling corresponds to an iron oxide content of 40% by volume.

If the aggregate has different grain sizes, a further advantageous embodiment of the invention results. The admixture of aggregate to the plastic material is also subject to high requirements because the aim is for the aggregate to be distributed as homogeneously as possible in the finished composite component. In this case, it has been found that an advantageous homogeneous distribution of the aggregates in the composite component can be achieved by mixing different grain sizes. The processing of plastic materials by admixing aggregates is also known as compounding and is mainly done in extruders.

In one embodiment of the invention, the aggregate has particles having a grain size of less than 5 μm and/or less than 16 μm and/or less than 80 μm. It has been found that the selection of the grain size allows a favorable distribution of the additives or aggregates to be achieved in the plastic material. Small proportions of grain sizes below 5 μm and about half the number of additives having grain sizes smaller than 16 μm are advantageous, on the one hand, to achieve a homogeneous distribution of the additives or aggregates in the plastic material and, on the other hand, to obtain sufficient strength in the composite component.

If the composite component has a density of aluminum, in particular a density of 2.7 g/cm³, this results in a further embodiment of the invention. Mass inertia elements are nowadays made from an iron or aluminum material, and these metals can have a mass inertia corresponding to the requirements. By using the composite component according to the invention consisting of plastic materials having additives made of metal powders, a density of, for example, aluminum can be produced. According to the invention, it is thus possible to produce a composite component that corresponds to a metal material and that is comparable with the specific properties of the metals, but at the same time has the advantageous parts of an injection-molded component. In addition to the design freedom that results from the manufacture of an injection molded component, mass inertia elements can also be manufactured more cost-effectively. Thus, according to the invention, the positive properties of metals are combined with those of the injection molding process in order to provide a composite component for a motor vehicle locking system that meets the requirements for a mass inertia lever or a mass inertia element.

If a mass inertia element is mentioned in the context of the invention, the mass inertia element can be a lever, but it can also be, for example, a displaceably mounted mass inertia element in a motor vehicle locking system. The main advantage of the invention is that the positive properties of the injection molding process are combined with those of the metal properties.

If the composite component has a bearing point, in particular an opening, and if the composite component is designed to be mass-balanced with respect to the bearing point, this results in a further embodiment of the invention. In order to prevent natural vibrations of the system, which can result, for example, from vibrations in the motor vehicle, it has proven to be advantageous if the composite component is designed to be mass-balanced around a bearing point. The composite component is preferably a mass inertia lever that is designed to be mass-balanced around an opening and, in particular, a bore. The structure according to the invention and, in particular, a combination of the advantageous design variants of the invention make it possible to produce a composite component that is particularly suitable for use in a motor vehicle locking system. Components made of polybutylene terephthalate PBT or polyamide offer the advantage that they have high strength and toughness, which at the same time have a noise-reducing effect and allow inexpensive storage, for example on a bearing pin. The additives and, in particular, a special selection of the additives with regard to the degree of filling and the grain size make it possible to adjust the density in such a way that an adaptation to the dimensions in the available installation space can be achieved. A composite component is thus provided that meets the high requirements placed on motor vehicle locking systems and at the same time meets the requirements of the automotive industry.

With regard to the method, the object of the invention is achieved in that a method for producing a composite component, in particular a composite component for a motor vehicle locking system, is provided, in which at least one metal aggregate, in particular an additive, is added to a plastic material, and then by means of injection molding a composite component is produced from the mixture. The method according to the invention makes it possible to produce a homogeneous distribution of the additives and, in particular, of a composite component according to any of claims 1 to 9 that combines the positive properties of injection molding with those of the metal additives.

The invention is explained in more detail in the following with reference to the attached drawings on the basis of a preferred exemplary embodiment. However, the principle applies that the exemplary embodiment does not limit the invention, but is merely an advantageous embodiment. The features shown can be implemented individually or in combination with further features of the description as well as the claims, individually or in combination.

In the Drawings:

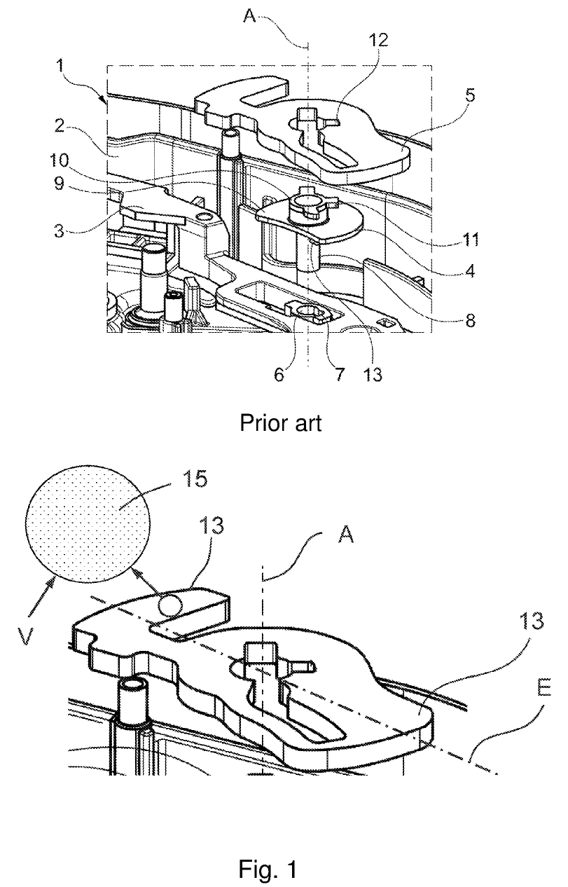

FIG. 1 shows an embodiment of a motor vehicle locking system having a mass inertia lever in a three-dimensional view of a motor vehicle lock, which is in some regions shown as an exploded view, and

FIG. 2 is a three-dimensional view of a mass inertia lever in an embodiment according to the invention.

FIG. 1 shows a motor vehicle lock 1 in a three-dimensional representation according to the prior art and according to DE 10 2018 116 313, only part of the components of the motor vehicle lock 1 being shown. A housing 2, a sliding element 3, a plastics pin 4 and a mass inertia element 5 are shown in FIG. 1. The mass inertia element 5 is fastened on the plastics pin 4 along an axis A, wherein the plastics pin 4 can be inserted into an opening 6 of the housing 2. An extension of the opening 7 can be seen in the opening 7, so that the plastics pin 4 can be inserted into the opening 6 in a form-fitting manner.

The plastics pin 4 has a cylindrical extension 8 that extends through the housing 2. A joining surface 9 serves, on the one hand, as a counter-bearing for, for example, riveting of the cylindrical extension 8 and, on the other hand, as a guide surface for the sliding element 3. In addition, the joining surface 9 has the task of safely guiding the mass inertia element 5 around the axis A during a pivoting movement. The plastics pin 4 has an extension 10 that extends through the mass inertia element 5. Starting from the extension extending through the mass inertia element 5, the plastics pin 4 has arms 11 that, starting from the plastics pin 4, extend outward. The arms 11 in this exemplary embodiment 3 cooperate with recesses 12 in the mass inertia element 5, so that the arms 11 can be guided through the recesses 12 in the mass inertia element 5. In this embodiment, the mass inertia element 5 serves to decouple a release lever chain in that the mass inertia element 5 counteracts an external impulse on the motor vehicle.

A mass inertia element 5 designed according to the invention is shown in FIG. 1. The mass inertia element 5 is designed to be mass-balanced around the axis A, so that natural oscillations due to vibrations, for example, can be prevented. It can be seen that the mass inertia element 5 has a complex external geometry that extends along a plane E due to the specified installation space.

The composite component 13 has a basic structure made of a plastic material 14 with additives 15 regularly arranged in the plastic material 14. As an example, an enlargement V is entered in FIG. 1 in order to illustrate the structural design of the composite component 13 by way of example. Of course, the structure of the composite component 13 made of a plastic material 14 allows very complex mass inertia elements 13, especially those adapted to the installation space, to be produced that, due to the metal additives, are comparable with those of metal mass inertia elements 5 in terms of their specific material properties.

### LIST OF REFERENCE SIGNS

1 motor vehicle lock
2 housing
3 sliding element
4 plastics pin
5 mass inertia element
6 opening
7 extension
8 cylindrical extension
9 joining surface
10 extension
11 arm
12 recess
13 composite component
14 plastic material
15 additives, aggregates
A axis
E plane

1. A composite component for use as a mass inertia element for a motor vehicle locking system, the composite component comprising:
a plastic material and a metal material, wherein the composite component includes granules of the plastic material with the metal material including at least one metal aggregate admixed with the granules of the plastic material.

2. The composite component according to claim 1, wherein the at least one metal aggregate includes at least one of iron and aluminum which is admixed to the plastic material.

3. The composite component according to claim 1, wherein the at least one metal aggregate includes at least one of an iron oxide and an aluminum alloy which is admixed to the plastic material.

4. The composite component according to claim 1, wherein the plastic material is a polybutylene terephthalate or a polyamide.

5. The composite component according to claim 1, wherein a degree of filling of the at least one metal aggregate of 55% by weight to 85% by weight of the composite component is admixed to the plastic material.

6. The composite component according to claim 1, wherein particles of the at least one metal aggregate have different grain sizes.

7. The composite component according to claim 6, wherein the at least one metal aggregate has particles having a grain size of less than 80 μm.

8. The composite component according to claim 1, wherein the composite component has a density of aluminum, of 2.7 g/cm³.

9. The composite component according to claim 1, wherein the composite component has a bearing point configured as an opening, and that the composite component is designed to be mass-balanced in relation to the bearing point.

10. A method for producing a composite component for use as an inertia element of a motor vehicle locking system comprising:
admixing a mixture including, at least one metal additive is-admixed to a plastic material; and
producing the composite component from the mixture by an injection molding process.

11. The composite component according to claim 5, wherein a degree of filling of the at least one metal aggregate of 60% percent by weight to 80% by weight of the composite component is admixed to the plastic material.

12. The composite component according to claim 5, wherein a degree of filling of the at least one metal aggregate of 65% percent by weight to 75% by weight of the composite component is admixed to the plastic material.

13. The composite component according to claim 7, wherein the at least one metal aggregate has particles having a grain size of less than 16 μm.

14. The composite component according to claim 7, the at least one metal aggregate has particles having a grain size of less than 5 μm.

15. The composite component according to claim 9, wherein the composite component is a mass inertia lever that is mass-balanced around the opening.

16. A motor vehicle lock comprising:
a housing;
a pin located within the housing;
a sliding element located within the housing and that slides relative to the pin; and
a mass inertia element that is fastened to the pin about an opening of the mass inertial element along a longitudinal axis of the pin, wherein the mass inertia element is configured as the composite component according to claim 1.

17. The motor vehicle lock of claim 16, wherein the pin has a cylindrical extension and a joining surface that provides a guiding surface for pivoting of the mass inertia element.

18. The motor vehicle lock of claim 16, wherein the pin has an extension that extends through the opening of the mass inertia element.

19. The motor vehicle lock of claim 16, wherein the pin is plastic.
